(19) United States
(12) Patent Application Publication
(10) Pub. No.: US 2011/0070007 A1
(43) Pub. Date: Mar. 24, 2011

(54) CONVEYING APPARATUS, IMAGE FORMING APPARATUS AND CONVEYING SYSTEM

(75) Inventors: Akira SUNAZAWA, Ebina-shi (JP); Atsunori SAKAI, Kasukabe-shi (JP); Katsunori SUZUKI, Saitama-shi (JP)

(73) Assignee: FUJI XEROX CO., LTD., Minato-ku, Tokyo (JP)

(21) Appl. No.: 12/855,920

(22) Filed: Aug. 13, 2010

(30) Foreign Application Priority Data
Sep. 24, 2009 (JP) 2009-219309

(51) Int. Cl. G03G 15/00; B65G 43/00

(52) U.S. Cl. 399/361; 198/341.01

(57) ABSTRACT

A conveying apparatus includes: a movable portion that performs an operation related to conveying an article to be conveyed when provided with a driving force; a first component that constitutes part of an exterior of the conveying apparatus, and is attachable and detachable with respect to the conveying apparatus; a second component that is openable and closable by a user in state where the first component is detached, through a space formed by the detached first component, and that operably exposes at least part of the movable portion to the user in an open state; and a drive controller that drives the movable portion in a case where the first component is detached and the second component is closed, and performs control to prevent at least part of the movable portion from being driven in a case where the first component is detached and the second component is open.

### CROSS-REFERENCE TO RELATED APPLICATIONS

This application claims priorities under 35 USC 119 from Japanese patent application No. 2009-219309 filed on Sep. 24, 2009.

### BACKGROUND

1. Technical Field

The present invention relates to a conveying apparatus, an image forming apparatus and a conveying system.

2. Related Art

There are, for example, image forming apparatuses provided with multiple sections for feeding sheets.

### SUMMARY

The present invention enables to reduce situations where conveying of an article to be conveyed stops.

According to one aspect of the invention, there is provided a conveying apparatus including a configuration provided with a movable portion that performs an operation related to conveying an article to be conveyed when provided with a driving force, a first component that constitutes part of an exterior of the conveying apparatus, and is attachable and detachable with respect to the conveying apparatus, a second component that is openable and closable by a user in state where the first component is detached, through a space formed by the detached first component, and that operably exposes at least part of the movable portion to the user in an open state, and a drive controller that drives the movable portion in a case where the first component is detached and the second component is closed, and performs control to prevent at least part of the movable portion from being driven in a case where the first component is detached and the second component is open.

### BRIEF DESCRIPTION OF THE DRAWINGS

Exemplary embodiment(s) of the present invention will be described in detail based on the following figures, wherein:

FIG. 1 shows a configuration of an image forming system;

FIG. 2 shows configurations of a second unit and a third unit in greater detail;

FIG. 3 shows the second unit;

FIG. 4 shows the third unit;

FIG. 5 illustrates three views of a configuration of a cover having a reflective portion on part of an insertion point;

FIG. 6 shows three views of other examples of the cover;

FIGS. 7A and 7B contrast the open and closed states of the cover;

FIG. 8 is a block diagram showing a configuration related to control of the image forming system; and

FIG. 9 is a flowchart showing processing executed in the image forming system.

### DETAILED DESCRIPTION

### Exemplary Embodiment

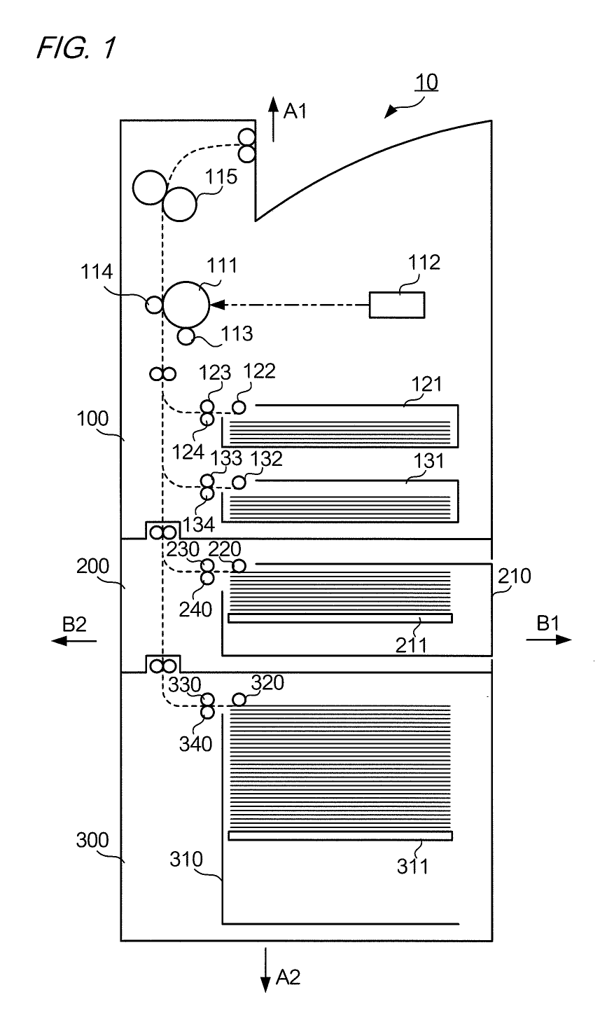

FIG. 1 shows a configuration of an image forming system serving as an exemplary embodiment of the present invention. As shown in this figure, an image forming system 10 of the exemplary embodiment is provided with a first unit 100, a second unit 200 and a third unit 300. Note that the units of the image forming system 10 may be constituted separately, that is, detachably, or may be constituted integrally.

The image forming system 10 of the exemplary embodiment uses sheets of predetermined size as articles to be conveyed. Herein, sheet refers to a sheet-like medium on which an image is to be formed using a color material (toner, etc.), but is not limited to so-called paper, and includes a sheet-like resin or the like. While there may be multiple types of sheets of various sizes (i.e., dimensions) and weights per unit area (so-called basis weight), in the exemplary embodiment the same type of sheet is assumed to be held in all of the holding portions.

Note that in the following, for ease of description, the direction of an arrow A1 in FIG. 1 will be referred to as “upward” and the direction of an arrow A2 will be referred to as “downward.” Also, the direction of an arrow B1 in FIG. 1 will be referred to as “frontward” and the direction of an arrow B2 will be referred to as “rearward.” Herein, frontward is the side from which the user operates, and rearward is the opposite side to frontward. The apparatuses according to an aspect of the invention are, however, not limited to being used in such an orientation or arrangement, and the configuration shown in FIG. 1 may, for example, be tilted at 90 degrees and the units used in an orientation whereby the units are arranged one behind the other.

Also, in the following, the surface on the upward side of each portion will be referred to as the “upper surface,” the surface on the downward side will be referred to as the “lower surface,” the surface on the frontward side will be referred to as the “front surface,” and the surface on the rearward side will be referred to as the “rear surface.”

The first unit 100 is provided with an image forming portion 110 and sheet feeding portions 120 and 130 that will be described later. The image forming portion 110 is an example of an image forming section according to an aspect of the invention, and in the exemplary embodiment is an eletrophotographic image forming section. The image forming portion 110 is provided with a photoconductor drum 111, an exposure apparatus 112, a developer 113, a transfer roller 114 and a fixer 115, and forms an image by transferring a toner image formed on the photoconductor drum 111 to a sheet and fixing the toner image. Note that the image forming portion 110, while here being a single-color image forming section, may also form an image using multi-color toner.

The sheet feeding portions 120 and 130 are sections that convey sheets. The sheet feeding portions 120 and 130 hold sheets, and feed held sheets as needed when provided with a driving force by a driving section (motor, etc.) that is not shown. The sheet feeding portion 120 (130) is provided with a holding portion 121 (131) that holds multiple sheets, a feed roller 122 (132) that dispatches sheets one at a time from the top of the held sheets, and conveying rollers 123 and 124 (133 and 134) that handle the dispatched sheets and convey the sheets on a conveying path (broken line in figure) one by one. The sheet feeding portion 120 and the sheet feeding portion 130 have common configurations related to the conveying of sheets, but may differ in the size and number of held sheets. Note that the multiple conveying rollers are provided in appropriate positions on the sheet conveying path.

The second unit 200 and the third unit 300 are examples of conveying apparatuses according to an aspect of the invention. The second unit 200 and the third unit 300 may be respectively regarded as separate conveying apparatuses, or as being combined to constitute a single conveying apparatus. The second unit 200 (third unit 300) includes a holding portion 210 (310), a feed roller 220 (320), and conveying rollers 230 and 240 (330 and 340). These constituent elements are at least provided with functions in common with the constituent elements of the same name included the sheet feeding portions 120 and 130. That is, these constituent elements all correspond to a movable portion that performs an operation related to conveying sheets when provided with a driving force.

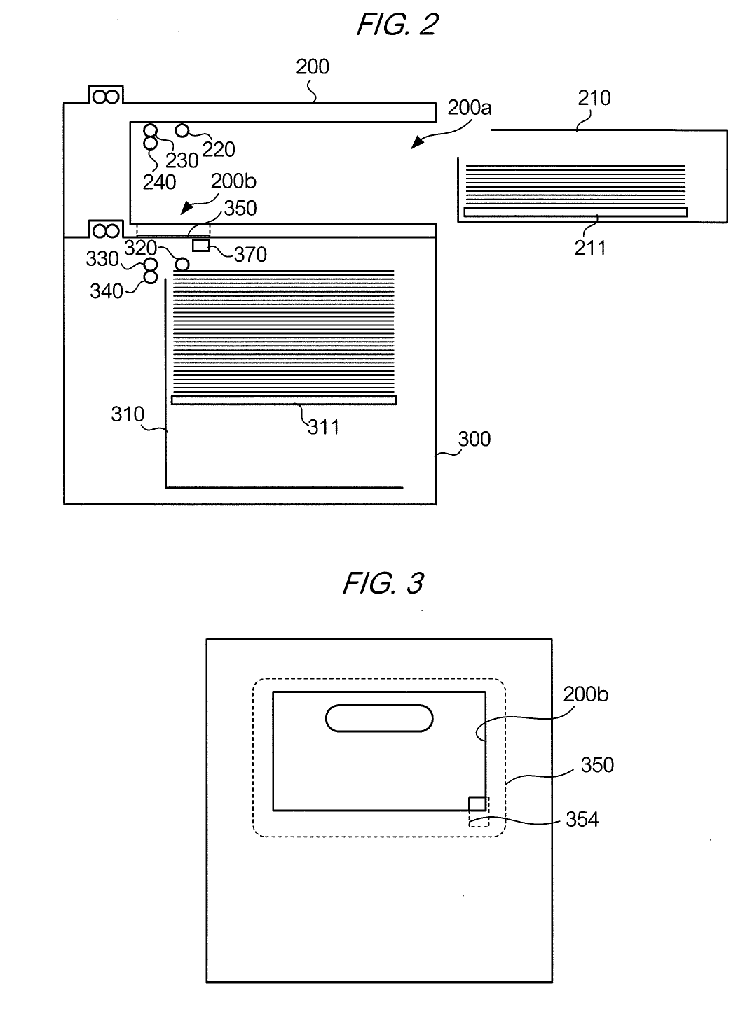

FIG. 2 shows the configurations of the second unit 200 and the third unit 300 in greater detail. The holding portion 210 is provided with a lift 211 that moves the sheets up and down. The lift 211 changes position as a result of being provided with a driving force, such that the uppermost of the sheets held in the holding portion 210 contacts the feed roller 220 at an appropriate pressure. The operation of raising the lift 211 will thus be referred to in the following as “lift up.” The lift 211 performs the lift up operation according to the number of remaining sheets. Thus, a sensor that detects the number of remaining sheets by weight or the like is provided on the lift 211.

The holding portion 210 is a component having a configuration that allows detachment from the second unit 200. Note that the second unit 200 is a collection of multiple components that have been combined. The attached state of the holding portion 210 is shown in FIG. 1 and the detached state is shown in FIG. 2. That is, the holding portion 210 is detached by being moved (pulled) frontward, and is attached by being moved (pushed) rearward. The holding portion 210 is an example of a first component according to an aspect of the invention.

The second unit 200 has a space for holding the holding portion 210, and permits the user to put a hand into this space when the holding portion 210 has been detached. Note that the user is not able to put a hand into this space when the holding portion 210 has been attached. This space opens frontward of the second unit 200. In the following, this opening will be referred to as an “opening 200a” as an example opening. The holding portion 210 has a function of blocking the opening 200a in an attached state. This function is realized by the holding portion 210 constituting part of the exterior of the second unit 200. In other words, the second unit 200 loses part of the exterior as a result of the holding portion 210 being detached, exposing the space holding the holding portion 210.

Also, the second unit 200 has an opening 200b on the lower surface. The opening 200b is provided in a position coinciding with a cover 350 that will be described later.

FIG. 3 shows the lower surface of the second unit 200 from the upward side. The opening 200b is large enough to permit opening and closing of the cover 350. The size of the opening 200b may be smaller than the size of the cover 350, provided opening and closing of the cover 350 is permitted. Note the lower surface of the second unit 200 desirably has few irregularities, so as to allow the user to clearly see the cover 350.

The holding portion 310 of the third unit 300 is provided with a lift 311. The function of the lift 311 is in common with the function of the lift 211. That is, the lift 311 also corresponds to an example of a movable portion according to an aspect of the invention. Note that the holding portion 310 may have sheets replenished by itself being pulled out, or the exterior of the front surface of the third unit 300 may be constituted by a door that opens and closes, and sheets may be replenished by opening this door.

Also, the third unit 300 is provided with the cover 350 on the upper surface. The cover 350 is a plate-like member that is opened and closed by the user, and is provided above the feed roller 320 or the conveying rollers 330 and 340. The cover 350 is an example of a second component according to an aspect of the invention.

In the exemplary embodiment, the feed roller 320 and the conveying rollers 330 and 340 are consumables that wear as a result of the conveying of sheets, and need to be replaced at appropriate times. Replacement of consumables is carried out by the user. Note that the user referred to here may be someone who forms images using the image forming system 10, or a professional (so-called service person) who carries out repairs on the image forming system 10, replacement of consumables, and the like.

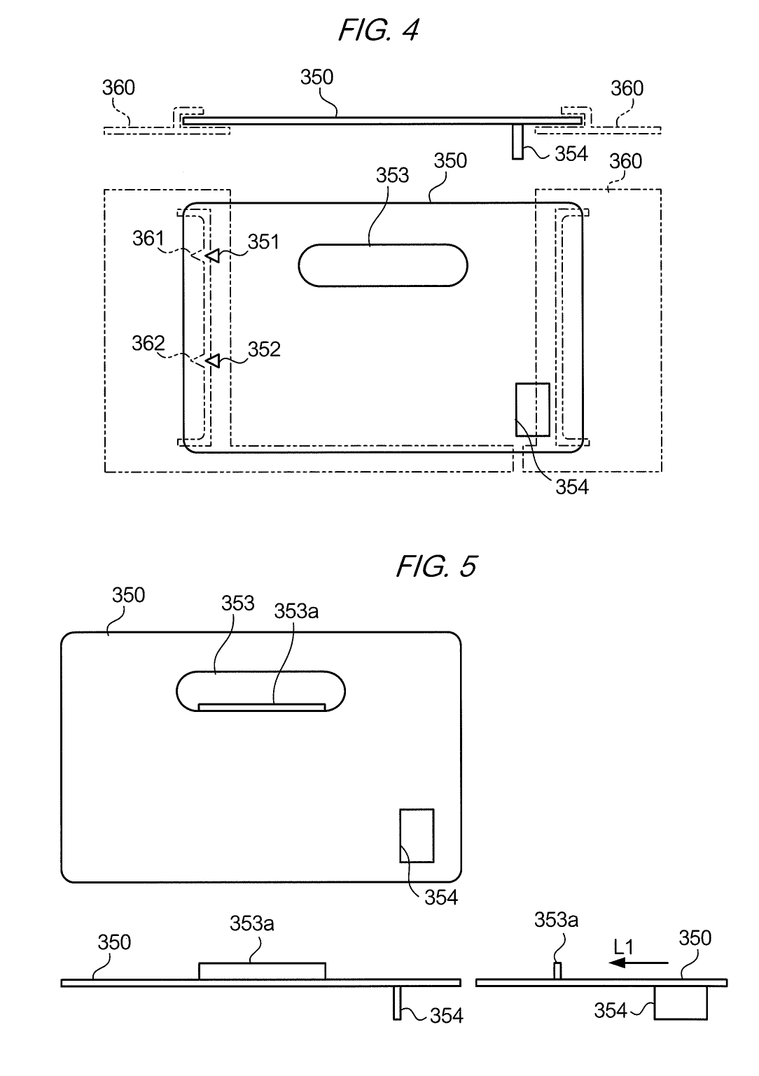

FIG. 4 shows a configuration of the upper surface side of the third unit 300, and a configuration of the cover 350 and the periphery thereof. The third unit 300 is provided with the cover 350 and a supporting member 360 supporting the cover 350. The supporting member 360 is provided with part thereof covering the upper surface of the cover 350, and restricts the upward and downward movement of the cover 350. The supporting member 360 also has notches 361 and 362. The notches 361 and 362 are indents provided as indicators of the movement of the cover 350. Note that since the user need only be provided with an indicator, the notches 361 and 362 may be substituted with stickers or the like that adhere a printed image or the like.

The cover 350 is provided with marks 351 and 352, an insertion point 353 and a shading portion 354. The marks 351 and 352 are indicators of the movement of the cover 350, and are provided in positions corresponding to the notches 361 and 362 of the supporting member 360. The marks 351 and 352 are, for example, holes, that is, openings, provided in the cover 350, but may be stickers or the like that adhere a printed image or the like. The insertion point 353 is an opening provided for the user to insert a finger. The insertion point 353 here has a shape that allows four fingers to be inserted, but may be a round opening that allows one finger to be inserted.

The insertion point 353 needs, however, to be small enough that fingers do not reach the feed roller 320 or the conveying rollers 330 and 340 from the insertion point, or to be provided in a position removed from the feed roller 320 and the conveying rollers 330 and 340 so that fingers to not reach the rollers. The shading portion 354 functions as a section that shades light irradiated by a second sensor 370 that will be discussed later. The shading portion 354 is, in the exemplary embodiment, a region created by cutting and folding back part of the cover 350. Note that instead of the shading portion 354 of the exemplary embodiment, a member having an equivalent function may be attached to the cover 350.

Note that the cover 350 desirably is constituted to have a reflective portion that reflects light incident through the opening 200a toward the opening 200a. This reflective portion more desirably is provided on part of the insertion point 353.

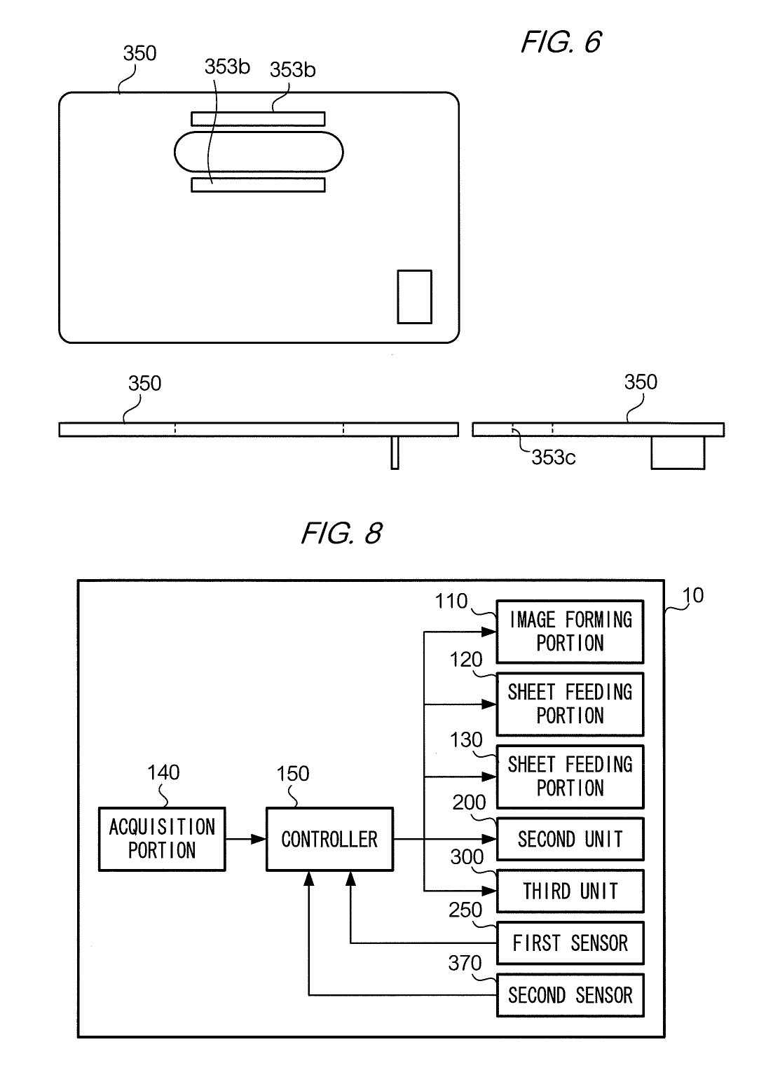

FIG. 5 illustrates three views of the configuration of the cover 350 that includes a reflective portion on part of the insertion point 353. The insertion point 353 shown in this figure has a reflective portion 353a formed by a bending process. The reflective portion 353a reflects light incident from the direction shown by an arrow L1 in this figure. That is, the reflective portion 353a reflects light toward the opening 200a if light is incident through the opening 200a. The reflective portion 353a makes it easy for the user to visually check the position of the insertion point 353. Note that the reflective portion 353a may be provided on the frontward side or the rearward side of the insertion point 353. Also, instead of the reflective portion 353a formed by a bending process, a reflective portion 353b such a sticker or a film that readily reflects incident light may be adhered around at least part of the opening 200a, or the cover 350 may be formed by solid metal, and the surface of the cover 350 in the thickness direction of the opening 200a may be used as a reflective portion 353c that reflects incident light, as shown in FIG. 6. The reflective portion 353c more desirably has a metallic sheen.

The cover 350, in an open state, operably exposes the feed roller 320 and the conveying rollers 330 and 340 to the user. The operation referred to here involves replacing or cleaning the feed roller 320 or the conveying rollers 330 and 340, for example. Also, the operation referred to here may, in the case where a sheet gets jammed in the feed roller 320 or the conveying roller 330 and 340, involve removing the jammed sheet.

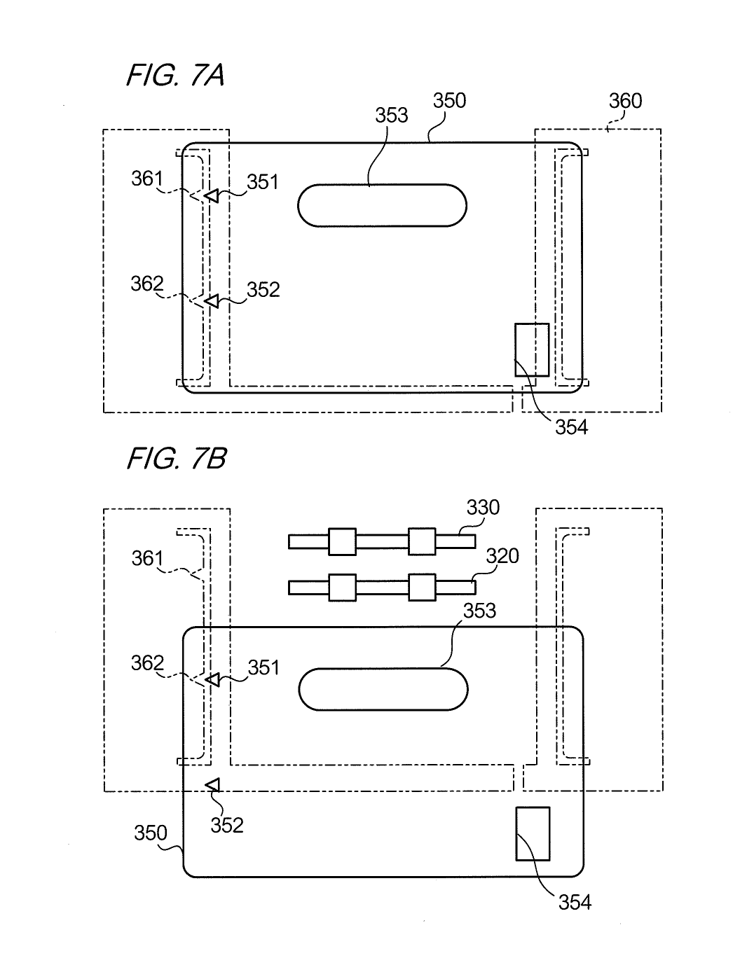

FIGS. 7A and 7B contrast the open and closed states of the cover 350, with FIG. 7A showing the closed state and FIG. 7B showing the open state. When the cover 350 is in the position shown in FIG. 7A, the mark 351 faces the notch 361, and the mark 352 faces the notch 362. In this state, the feed roller 320 and the conveying rollers 330 and 340 are not operably exposed. Note that while the feed roller 320 and the conveying rollers 330 and 340 may be partially visible through the insertion point 353, the abovementioned replacement operation and the like will not be possible even if the rollers are partially visible through the insertion point 353. When the cover 350 is in the position shown in FIG. 7B, the mark 351 faces the notch 362. In this state, the feed roller 320 and the conveying rollers 330 and 340 are operably exposed.

FIG. 8 is a block diagram showing a configuration related to control of the image forming system 10. The image forming system 10 is provided with an acquisition portion 140, a controller 150, a first sensor 250 and the second sensor 370, in addition to the abovementioned image forming portion 110, sheet feeding portion 120, sheet feeding portion 130, second unit 200 and third unit 300. Note that the acquisition portion 140 and the controller 150 may be provided in any of the first unit 100, the second unit 200 and the third unit 300.

The acquisition portion 140 acquires commands related to image forming. The acquisition portion 140 acquires commands via a manipulator such as a button provided in the image forming system 10, or via a communication section connected to an external apparatus. Commands acquired by the acquisition portion 140 include data relating to sheets to be used and image data representing images to be formed. The controller 150 is provided with an operation processing apparatus such as a CPU (Central Processing Unit) and a memory, and controls operation of the constituent elements of the image forming system 10 by executing processing according to prestored programs. The controller 150 performs selection of sheets for forming images, according to commands acquired by the acquisition portion 140. The controller 150 is an example of a drive controller according to an aspect of the invention.

The first sensor 250 is a detection section that detects that the holding portion 210 (i.e., first component) of the second unit 200 has been detached. The first sensor 250 detects the position of an object for detection using a physical quantity. The physical quantity referred to here is light reflectivity, pressure, electrical current or the like. The second sensor 370 is a detection section that detects the state of the cover 350 of the third unit 300. In the exemplary embodiment, the second sensor 370 is provided with an irradiation portion for irradiating light and a detection portion for detecting irradiated light, and detects whether the cover 350 is in an open state or a closed state depending on whether or not the shading portion 354 is shading light. The detection results of the first sensor 250 and the second sensor 370 are supplied as data to the controller 150.

The composition of the image forming system 10 of the present invention is as described above. With this configuration, the image forming system 10 forms an image using one of the held sheets. The image forming system 10 controls the driving of the constituent elements when forming an image, such that constituent elements that are required operate and the other constituent elements do not operate. The image forming system 10, specifically, executes the following processing.

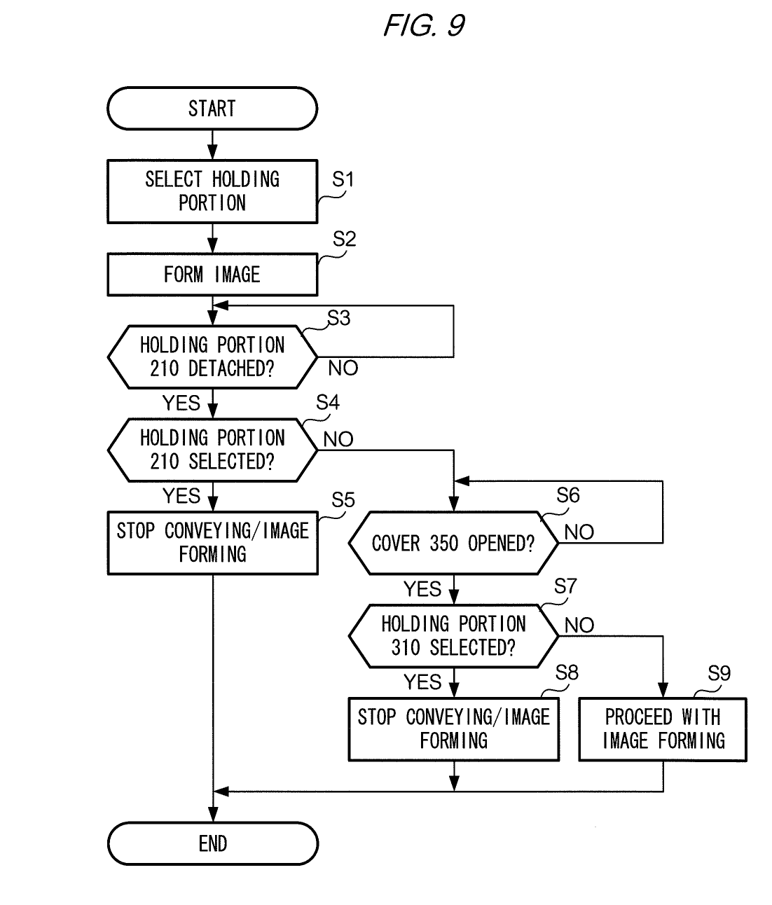

FIG. 9 is a flowchart showing processing executed when the controller 150 of the image forming system 10 forms an image. Note that the processing in this figure assumes the case where multiple sheets are repeatedly conveyed and images are repeatedly formed. Also, the image forming system 10 is initially assumed to be in a state where the holding portion 210 is attached and the cover 350 is closed.

The controller 150, when forming an image, firstly selects a holding portion for feeding sheets (step S1). The holding portion selected here is one of the holding portions 121, 131, 210 and 310. Subsequently, the controller 150 causes the holding portion selected in step S1 to convey sheets, and causes the image forming portion 110 to form images (step S2).

Note that in step S1, the controller 150 may perform lift up with regard to all of the holding portions, irrespective of which holding portion was selected.

The controller 150 judges whether the holding portion 210 has been detached, based on data supplied from the first sensor 250 (step S3). The controller 150 continues the operation of forming images, provided the holding portion 210 remains attached. On the other hand, in the case where the holding portion 210 has been detached, the controller 150 determines whether the holding portion selected in step S1 was the holding portion 210 (step S4). That is, at this time the controller 150 judges whether the holding portion 210 is performing an operation related to conveying sheets. Herein, in the case where the holding portion 210 has been selected, that is, the holding portion 210 is conveying sheets, the controller 150 causes the holding portion 210 to stop conveying sheets, and causes the image forming portion 110 to stop forming images (step S5). Herein, the operation of stopping the conveying of sheets involves stopping the feed roller 220 and the conveying rollers 230 and 240, and causing the lift 211 to not be raised. Also, the operation of causing the lift 211 to not be raised includes the case where the lift 211 is stopped from moving and the case where the lift 211 is lowered.

On the other hand, if the holding portion 210 has not been selected, the controller 150 judges whether the cover 350 has been opened, based on data supplied from the second sensor 370 (step S6). The controller 150 continues the operation of forming images, provided the cover 350 remains closed. Here, if the cover 350 has been opened, the controller 150 judges whether the holding portion selected in step S1 was the holding portion 310 (step S7).

If the holding portion 310 has been selected, the controller 150 causes the holding portion 310 to stop conveying sheets, and causes the image forming portion 110 to stop forming images (step S8). On the other hand, if the holding portion 310 has not been selected, the controller 150 proceeds without stopping the forming of images (step S9). At this time, the controller 150 lowers the lift 311 if lift up is being performed with regard to the holding portion 310.

Herein, the operation of stopping the forming of images and the operation of lowering the lift 311 are both examples of an operation of preventing the driving of a movable portion. For example, the operation of lowering the lift 311 can be said to be an operation of preventing driving related to the conveying of sheets by the lift 311, given that it exerts an opposite effect to the operation (lift up) required for conveying sheets. In other words, herein, “preventing driving” is a state where control is performed such that conveying of sheets and forming of images are not performed, and does not only indicate a state where driving is stopped.

Note that in steps S5 and S8, instead of causing the image forming portion 110 to stop forming images, the controller 150 may reselect a different holding portion (holding portion 121 or 131) from holding portions previously selected and proceed without causing the forming of images to be stopped.

### Variations

The abovementioned exemplary embodiment is an example of the present invention. The present invention is not limited to the abovementioned exemplary embodiment, and may be implemented by the following variations, for example. Also, the present invention does not obstruct implementation in which the following variations are appropriately combined.

### Variation 1

The present invention can be implemented by a configuration that does not include an image forming section. In the case of the abovementioned exemplary embodiment, for example, a conveying apparatus (or conveying system) constituted by the second unit 200 and the third unit 300 but not including the first unit 100 is equivalent to an exemplary embodiment of the present invention. Also, the present invention may be applied to other articles to be carried, without being limited to sheets.

### Variation 2

The abovementioned first unit 100, second unit 200 and third unit 300 may constitute a different combination from the abovementioned image forming system 10. For example, the second unit 200 need not be provided between the first unit 100 and the third unit 300, or multiple second units 200 may be provided between the first unit 100 and the third unit 300. In the former example, the first unit 100 has a configuration in which the holding portion 131 is detachable, and an opening is provided in a position on the lower surface side coinciding with the cover 350. In the later example, the second units 200 desirably are provided with a cover similar to the cover 350 on the upper surface side.

### Variation 3

The opening and closing mode of the second component according to an aspect of the invention is not limited to the mode of the abovementioned exemplary embodiment. For example, the cover 350 may be transformed so as to be detachable and removable without upward movement being restricted by the supporting member 360, or may be transformed so as to be attached to the supporting member 360 using a member such as hinge, and to open and close by rotating about a given axis. Alternatively, the cover 350 may be transformed so as to be powered open and closed as a result of the user pressing a manipulator.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A conveying apparatus comprising:
a movable portion that performs an operation related to conveying an article to be conveyed when provided with a driving force;
a first component that constitutes part of an exterior of the conveying apparatus, and is attachable and detachable with respect to the conveying apparatus;
a second component that is openable and closable by a user in state where the first component is detached, through a space formed by the detached first component, and that operably exposes at least part of the movable portion to the user in an open state; and
a drive controller that drives the movable portion in a case where the first component is detached and the second component is closed, and performs control to prevent at least part of the movable portion from being driven in a case where the first component is detached and the second component is open.

2. The conveying apparatus according to claim 1, wherein the second component includes a reflective portion that reflects light incident through an opening resulting from the first component being detached toward the opening.

3. The conveying apparatus according to claim 2, wherein the second component includes an insertion point for the user to insert a finger, and the reflective portion is provided on the insertion point.

4. The conveying apparatus according to claim 1, wherein the first component is attached and detached by moving in a set direction, and the second component is opened and closed by moving in a same direction as the set direction.

5. An image forming apparatus comprising:
a conveying apparatus according to one of claim 1; and
an image forming section that forms an image on an article to be conveyed that has been conveyed by the conveying apparatus.

6. A conveying system comprising:
a first conveying apparatus including a first component that constitutes part of an exterior of the first conveying apparatus and is attachable and detachable with respect to the first conveying apparatus, and performing an operation related to conveying an article to be conveyed when provided with a driving force;
a second conveying apparatus including:
a movable portion that performs an operation related to conveying an article to be conveyed when provided with a driving force; and
a second component that is openable and closable by a user in state where the first component is detached, through a space formed by the detached first component, and that operably exposes at least part of the movable portion to the user in an open state; and
a drive controller driving the movable portion in a case where the first component is detached and the second component is closed, and performing control to prevent at least part of the movable portion from being driven in a case where the first component is detached and the second component is open.
